(19) United States
(12) Patent Application Publication
(10) Pub. No.: US 2026/0327872 A1
(43) Pub. Date: Oct. 22, 2026

(54) NONWOVEN MAT

(71) Applicants: ORKLI S. COOP, Ordizia, Gipuzkoa (ES); BELCHEM GmbH, Freiberg (DE)

(72) Inventors: Marco BORONAT ELIZALDE, Ordizia, Gipuzkoa (ES); lñigo HERNÁNDEZ CONDE, Ordizia, Gipuzkoa (ES); Francisco Javier GONZÁLEZ SALVADOR, Ordizia, Gipuzkoa (ES); Francisca SCHMIDT, Freiberg (DE); Dario HEIDRICH, Freiberg (DE)

(21) Appl. No.: 19/484,518

(22) PCT Filed: Apr. 9, 2024
(86) PCT No.: PCT/EP2024/059589

§ 371 Date: Nov. 14, 2025

(30) Foreign Application Priority Data
May 16, 2023 (EP) 23382456.4

(51) Int. Cl. D04H 1/4209; D04H 1/64; D04H 1/732; H01M 50/293

(52) U.S. Cl. CPC D04H 1/4209; D04H 1/64; D04H 1/732; D10B 2401/04; H01M 50/293

(57) ABSTRACT

The present invention refers to a nonwoven mat for thermal insulation and protection from fire, a method for the preparation of said nonwoven mat, a partition member, a battery housing and a battery pack; and to the use of the nonwoven mat, the battery spacer and the battery housing for thermal insulation and protection from fire.

### FIELD OF THE INVENTION

The present invention relates to the area of insulation and protection from fire. More specifically, the present invention relates to a nonwoven mat for thermal insulation and protection from fire, a method for the preparation of said nowoven mat, a partition member, a battery housing and to the use of the nonwoven mat, the partition member, and the battery housing.

### BACKGROUND

Rechargeable electrical storage systems comprising several battery cells, such as lithium-ion cells, are known and used in several fields such as electric or hybrid vehicles. Sometimes rechargeable battery cells suffer an internal overheating and enter an uncontrollable, self-heating state that may lead to a “thermal runaway” event. Thermal runaway events in lithium-ion cells can result in temperatures up to 1300° C. or even higher, ejection of gas, shrapnel or particulates. Consequently, during these events it is necessary interrupting or reducing heat transfer from defective cells to other parts of the electrical storage system to avoid or reduce damage.

Inorganic materials such as man-made inorganic materials have good thermal properties and are useful for several applications wherein resistance to high temperatures is required, being common materials in the composition of insulating materials. Thus, one possible solution for interrupting or reducing heat transfer from a thermal runaway event from an overheated battery cell, is adding thermally insulating barriers comprising man-made inorganic materials between battery cells. However, the specifications that those insulating barriers need to fulfill to be able to work with batteries are strict and, in many cases, the barriers of the state of the art do not fulfill the mechanical requirements needed.

Therefore, there is a clear need for new materials and barriers suitable for thermal insulation and protection from fire with high quality, performance, strength and durability characteristics.

### BRIEF DESCRIPTION OF THE INVENTION

The authors of the present invention have developed a nonwoven mat for thermal insulation and protection from fire, a method for the preparation of said nowoven mat, a partition member, a battery housing and a battery pack.

In particular, it has been observed that the nonwoven mat of the present invention has a surprisingly structural integrity and mechanical properties significantly improved over previously disclosed thermal insulating mats. The mechanical properties of the nonwoven mat of the present invention, such as its deformation behaviour under pressure, are particularly suitable for acting as thermal insulation and fire protection in battery-related applications.

The method of the present invention allows obtaining nonwoven mats with tunable mechanical properties. In addition, since the method for the preparation of the nonwoven mat of the present invention is a simple and inexpensive procedure, it can be applied for large-scale production of nonwoven mats.

Therefore, a first aspect of the invention is directed to a nonwoven mat for thermal insulation and protection from fire obtainable by a method comprising the steps of:
i) providing a dispersion comprising:
   a plurality of man-made inorganic fibers comprising hydroxyl groups (OH) on their surface and wherein said plurality of man-made inorganic fibers have a mean diameter equal or over 6 microns;
   a polymeric binder; and
   a solvent;
ii) web forming said dispersion to obtain a nonwoven surface;
iii) drying the nonwoven surface of step (ii) under suction until the nonwoven surface has less than a 40% by weigh of the solvent of the total weight of the nonwoven surface;
iv) infiltrating under suction the nonwoven surface of step (iii) with a mixture comprising at least a binder to obtain an infiltrated nonwoven surface; and
v) heating the infiltrated nonwoven surface obtained in step (iv) at a temperature between 3° and 300° C. to obtain a nonwoven mat.

In a second aspect, the present invention is directed to a method for the preparation of the nonwoven mat for thermal insulation and protection from fire comprising the steps of
i) providing a dispersion comprising:
   a plurality of man-made inorganic fibers comprising hydroxyl groups (OH) on their surface, wherein said plurality of man-made inorganic fibers have a mean diameter equal or over 6 microns;
   a polymeric binder; and
   a solvent;
ii) web forming said dispersion to obtain a nonwoven surface;
iii) drying the nonwoven surface of step (ii) under suction until the nonwoven surface has less than a 40% by weigh of the solvent of the total weight of the nonwoven surface;
iv) infiltrating under suction the nonwoven surface of step (iii) with a mixture comprising at least a binder to obtain an infiltrated nonwoven surface; and
v) heating the infiltrated nonwoven surface obtained in step (iv) at a temperature between 3° and 300° C. to obtain a nonwoven mat.

In a further aspect, the present invention is directed to a partition member adapted for forming a partition: (i) between two battery cells or (ii) between a single battery cell and a member other than said single battery cell, wherein the partition member comprises at least one nonwoven mat of the present invention as described in any of its particular embodiments.

In an additional aspect, the present invention is directed to a battery housing that defines at least an open cavity for receiving at least one battery cell and preferably a plurality of battery cells forming a pack of cells; wherein the battery housing comprises the partition member of the present invention as described in any of its particular embodiments and/or the nowoven mat as described in any of its particular embodiments.

In another aspect, the present invention is directed to a battery pack comprising:
a plurality of batteries, and
the partition member and/or the battery housing of the present invention as described in any of its particular embodiments.

In another aspect, the present invention is directed to the use of the nonwoven mat, the partition member, or the battery housing of the invention for thermal insulation, preferably for thermal insulation of batteries; more preferably for thermal insulation of batteries of electric vehicles.

In yet another aspect, the present invention is directed to the use of the nonwoven mat, the partition member, or the battery housing of the invention for fire protection, preferably for fire protection of batteries; more preferably for fire protection of batteries of electric vehicles.

### FIGURES

FIG. 1: Results for the deformation rate (%) under pressure for different nonwoven mats.

FIG. 2: Scanning electron microscopy micrograph of a nonwoven mat.

FIG. 3: Results for the deformation rate (%) under pressure for nonwoven mats having different infiltrated binders.

FIG. 4: Image of a nonwoven surface being web formed.

FIG. 5: Image of a compression fixture used in the deformation rate (%) under pressure tests.

FIG. 6: Image of part of a battery housing comprising a nonwoven mat.

### DETAILED DESCRIPTION OF THE INVENTION

Unless defined otherwise, all technical and scientific terms used herein have the same meaning as commonly understood to one of ordinary skill in the art to which this disclosure belongs. As used herein, the singular forms “a” “an” and “the” include plural reference unless the context clearly dictates otherwise.

### Nonwoven Mat

The present invention refers to a nonwoven mat for thermal insulation obtainable by a method comprising the steps of:
i) providing a dispersion comprising:
   a plurality of man-made inorganic fibers comprising hydroxyl groups (OH) on their surface, wherein said plurality of man-made inorganic fibers have a mean diameter equal or over 6 microns;
   a polymeric binder; and
   a solvent;
ii) web forming the dispersion of step (i) to obtain a nonwoven surface;
iii) drying the nonwoven surface of step (ii) under suction until the nonwoven surface has less than a 40% by weigh of the solvent of the total weight of the nonwoven surface;
iv) infiltrating under suction the nonwoven surface of step (iii) with a mixture comprising at least a binder to obtain an infiltrated nonwoven surface; and
v) heating the infiltrated nonwoven surface obtained in step (iv) at a temperature between 3° and 300° C. to obtain a nonwoven mat.
i) providing a dispersion comprising:
   a plurality of man-made inorganic fibers having hydroxyl groups (OH) on their surface, wherein said plurality of man-made inorganic fibers have a mean diameter equal or over 6 microns;
   a polymeric binder; and
   a solvent;
ii) web forming the dispersion of step (i) to obtain a nonwoven surface;
iii) drying the nonwoven surface of step (ii) under suction until the nonwoven surface has less than a 40% by weigh of the solvent of the total weight of the nonwoven surface;
iv) infiltrating under suction the nonwoven surface of step (iii) with a mixture comprising at least a binder to obtain an infiltrated nonwoven surface; and
v) heating the infiltrated nonwoven surface obtained in step (iv) at a temperature between 3° and 300° C.

### Step (i)

In a particular embodiment, the dispersion of step (i) consists of:
a plurality of man-made inorganic fibers comprising hydroxyl groups (OH) on their surface, wherein said plurality of man-made inorganic fibers have a mean diameter equal or over 6 microns;
a polymeric binder; and
a solvent.

In another particular embodiment, the dispersion of step (i) consists of:
a mixture of:
   a) a plurality of man-made inorganic fibers comprising hydroxyl groups (OH) on their surface, wherein said plurality of man-made inorganic fibers have a mean diameter equal or over 6 microns; and
   b) a plurality of man-made inorganic fibers not having hydroxyl groups (OH) on their surface;
a polymeric binder; and
a solvent.

In another particular embodiment, the dispersion of step (i) consists of:
a mixture of:
   a) a plurality of man-made inorganic fibers comprising hydroxyl groups (OH) on their surface, and
   b) a plurality of man-made inorganic fibers not having hydroxyl groups (OH), particularly on their surface;
wherein said plurality of man-made inorganic fibers (a) and (b) have a mean diameter equal or over 6 microns;
a polymeric binder; and
a solvent.

In the context of the present invention, the expression “man-made inorganic fibers” refers to fibers not occurring naturally, such as artificial fibers, that consist essentially of inorganic materials such as ceramic oxides, non-oxide ceramics or combinations thereof. Non-limiting examples of “ceramic oxides” are alumina, alumina-silica, alumina-boria-silica, aluminum silicate, aluminum borosilicate, alumina-mullite, silica, zirconia, zirconia-silica, titania, titania-silica, rare earth oxides or a combination thereof. Non limiting examples of “non-oxide ceramics” are silicon carbide, silicon carbonitride, silicon oxycarbide, silicon titanium oxycarbide, silicon nitride, aluminum nitride, silicon titanium, silicon alumina nitride or a combination thereof.

In a particular embodiment, the man-made inorganic fibers of the nonwoven mat are man-made inorganic mineral fibers. In the context of the present invention the term “mineral” refers to fibers that are non-metallic inorganic fibers.

In a particular embodiment, the man-made inorganic fibers of the nonwoven mat are selected from commercially available man-made inorganic fibers. Non-limiting examples of commercially available man-made inorganic fibers include glass fibers, quartz fibers, aluminum borosilicate fibers, aluminum silicate, silica fibers, non-oxide fibers (for example, silicon carbide, silicon carbonitride, silicon oxycarbide, silicon titanium oxycarbide), as well as those man-made inorganic oxide fibers marketed by 3M Company (Saint Paul, MN) under the trade designation “NEXTEL” (for example, “NEXTEL 312”, “NEXTEL 440”, “NEXTEL 550”, “NEXTEL 610”, “NEXTEL 650”, and “NEXTEL 720”), by BELCHEM GmbH (Freiberg, Germany) under the trade designation “BELCOTEX®”, by COI Ceramics Company under the trade designation of “NICALON FIBER” (for example, “NICALON”, “HI-NICALON” and “Hi-Nicalon Type S”), by UBE Industries under the trade designation of “Tyranno fiber” or by Hitco Carbon Composites, Inc. (Gardena, CA) under the trade designation “REFRASIL”.

In a particular embodiment, the man-made inorganic fibers are selected from fibers that comprise substantially alumina (Al₂O₃), alumina-mullite, alumina-silica, aluminum borosilicate, aluminium silicate, silica (SiO₂) or a mixture thereof.

In a more particular embodiment, the man-made inorganic fibers are selected from alumina-silica based fibers, aluminium silicate based fibers, silica (SiO₂) based fibers or a mixture thereof.

In an embodiment, the man-made inorganic fibers comprising hydroxyl groups (OH) on their surface have a composition comprising Si; preferably a composition comprising Al and Si; more preferably a composition comprising SiO₂ and Al₂O₃. In a particular embodiment, the man-made inorganic fibers have hydroxyl groups (OH) on their surface and comprise silicon atoms in their composition; wherein the hydroxyl groups are covalently bonded to the silicon atoms of said fibers.

In a particular embodiment, the man-made inorganic fibers have a composition comprising more than 50% (wt.) of SiO₂; preferably more than 60% (wt.) of SiO₂; preferably from 70 to 99% (wt.) of SiO₂; more preferably a composition further comprising from 1 to 20% (wt.) of Al₂O₃.

In a more particular embodiment, the man-made inorganic fibers have a composition comprising:
from 80 to 99% (wt.) of SiO₂;
from 1 to 20% (wt.) of Al₂O₃; and
one or more components selected from Na₂O, K₂O, CaO, MgO, B₂O₃, TiO₂, Fe oxides, ZrO₂, BaO, PbO, ZnO, Cr₂O₃ and F.

In a more particular embodiment, the man-made inorganic fibers have a composition consisting essentially of:
from 80 to 99% (wt.) of SiO₂;
from 1 to 20% (wt.) of Al₂O₃; and
one or more components selected from Na₂O, K₂O, CaO, MgO, B₂O₃, TiO₂, Fe oxides, ZrO₂, BaO, PbO, ZnO, Cr₂O₃ and F.

The hydroxyl groups of the man-made inorganic fibers comprising hydroxyl groups on their surface are covalently bonded to the surface of the man-made inorganic fibers; preferably to Si atoms of the man-made inorganic fibers. In an more particular embodiment, the man-made inorganic fibers comprising hydroxyl groups on their surface have a composition comprising Si atoms, wherein at least a 20% of the Si atoms are covalently bonded to hydroxyl groups; preferably wherein at least a 25% of the Si atoms are covalently bonded to hydroxyl groups; more preferably wherein between 30 and 50% of the Si atoms are covalently bonded to hydroxyl groups; more preferably wherein about 40% of the Si atoms are covalently bonded to hydroxyl groups.

In a more particular embodiment, the man-made inorganic fibers comprising hydroxyl groups (OH) on their surface have been obtained by a method comprising the step of extracting with an acid those fibers; preferably wherein the man-made inorganic fibers have a composition comprising from 70 to 99% (wt.) of SiO₂; more preferably wherein the man-made inorganic fibers have a composition comprising:
from 80 to 99% (wt.) of SiO₂;
from 1 to 20% (wt.) of Al₂O₃; and
   one or more components selected from Na₂O, K₂O, CaO, MgO, B₂O₃, TiO₂, Fe oxides, ZrO₂, BaO, PbO, ZnO, Cr₂O₃ and F.

In a particular embodiment, the man-made inorganic fibers have
(i) a composition comprising:
   from 85 to 99% (wt.) of SiO₂;
   from 1 to 5% (wt.) of Al₂O₃; and
   one or more components selected from Na₂O, K₂O, CaO, MgO, B₂O₃, TiO₂, Fe oxides, ZrO₂, BaO, PbO, ZnO, Cr₂O₃ and F; and/or
(ii) a composition comprising:
   from 80 to 95% (wt.) of SiO₂;
   from 5 to 20% (wt.) of Al₂O₃; and
   one or more components selected from Na₂O, K₂O, CaO, MgO, B₂O₃, TiO₂, Fe oxides, ZrO₂, BaO, PbO, ZnO, Cr₂O₃ and F.

In a more particular embodiment, the man-made inorganic fibers have a composition comprising:
from 90 to 98% (wt.) of SiO₂;
from 2 to 5% (wt.) of Al₂O₃, and
   one or more components selected from Na₂O, K₂O, CaO, MgO, B₂O₃, TiO₂, Fe oxides, ZrO₂, BaO, PbO, ZnO, Cr₂O₃ and F; preferably the composition comprises from 0 to 3% (wt.) of Na₂O and/or K₂O; and one or more components selected from CaO, MgO, B₂O₃, TiO₂, Fe oxides, ZrO₂, BaO, PbO, ZnO, Cr₂O₃ and F.

In a more particular embodiment, the man-made inorganic fibers have a composition comprising:
from 81 to 94% (wt.) of SiO₂;
from 6 to 19% (wt.) of Al₂O₃; and
one or more components selected from Na₂O, K₂O, CaO, MgO, B₂O₃, TiO₂, Fe oxides, ZrO₂, BaO, PbO, ZnO, Cr₂O₃ and F; preferably comprising from 2 to 12% (wt.) of ZrO₂ and one or more components selected from Na₂O, K₂O, CaO, MgO, B₂O₃, TiO₂, Fe oxides, BaO, PbO, ZnO, Cr₂O₃ and F.

In a more particular embodiment, the man-made inorganic fibers comprise Al and Si in a molar ratio of about 1:18 of Al:Si.

In the context of the present invention the term “wt.” refers to a weight percentage of the total weight of the product or the composition as known in the art.

In an embodiment, the man-made inorganic fibers of step (i) have a mean diameter equal or over 7 microns; preferably equal or over 8 microns; more preferably equal or over 9 microns; more preferably equal or over 10 microns.

In an embodiment, the man-made inorganic fibers of step (i) have a mean diameter equal or between 6 and 50 microns; preferably equal or between 7 and 40 microns; preferably equal or between 7.5 and 30 microns; more preferably have a mean diameter of about 11 microns.

In the context of the present invention, the expression “mean diameter” regarding the fibers is a synonym as “mean thickness” of the fibers and it's a parameter that has been measured as the arithmetic mean of the diameters of a representative sample of the plurality of man-made inorganic fibers, in addition, said parameter has been measured by means known in the art such as scanning microscopy. In the context of the present invention the expression “fiber diameter” or “fiber diameters” relates to the shorter dimension of a fiber. In the context of the present invention the expression “fiber length” or “fiber lengths” relates to the longer dimension of a fiber.

In a particular embodiment, the man-made inorganic fibers of step (i) are chopped fibers. In a particular embodiment, the man-made inorganic fibers of step (i) are dispersed. In the context of the present invention, the term “dispersed” means the opposite of aggregated or agglomerated. Non-limiting examples of individual man-made inorganic fibers suitable for the present invention include straight, crimped or roving fibers.

In a particular embodiment, the dispersion of step (i) further comprises man-made inorganic fibers not having hydroxyl groups (OH), particularly not having hydroxyl groups (OH) on their surface, such as annealed man-made inorganic fibers. The man-made inorganic fibers not having hydroxyl groups (OH) may present all the characteristics defined above for the man-made inorganic fibers of step (i) in any of the embodiments described above.

In the context of the present invention, man-made inorganic fibers not having hydroxyl groups (OH), particularly on their surface, is understood as fibers comprising Si atoms wherein less than a 15% of those Si atoms are covalently bonded to an hydroxyl group; preferably wherein less than 10%; more preferably less than 5%; even much more preferably less than 3%, 2% or 1%.

In a more particular embodiment, the man-made inorganic fibers comprising hydroxyl groups (OH) on their surface of the dispersion of step (i) are in an amount below a 60% by weight of the total weight of man-made inorganic fibers of the dispersion of step (i); preferably below a 50%; more preferably below a 40%; even much more preferably below a 30%.

In a more particular embodiment, the man-made inorganic fibers comprising hydroxyl groups (OH) on their surface of the dispersion of step (i) are in an amount from 10 to 60% by weight of the total weight of man-made inorganic fibers of the dispersion of step (i); preferably from 15 to 50%; more preferably from 20 to 40%; even much more preferably from 25 to 30%.

The authors of the present invention believe that using man-made inorganic fibers with a mean diameter equal or over 6 microns and comprising hydroxyl groups (OH) on their surface in the dispersion of step (i), and particularly in the case of fibers with a mean diameter of about 11 microns, improves the drying of the nonwoven surface in step (ii) and, consequently, the subsequent interaction of the fibers with the infiltrated binders under suction in the nonwoven mat, leading to an increased durability and resistance to high temperatures and fire of the nonwoven mat of the present invention, and to better mechanical properties over those described in the art. In addition, the authors of the present invention have observed that using man-made inorganic fibers with a mean diameter of equal or over 6 microns lead to products with high porosity and flexibility that are easy to manipulate and to assemble.

Moreover, the authors of the present invention have oberserved a reduced amount of defects when the nonwoven mat comprises a mixture of man-made inorganic fibers with and without hydroxyl groups (OH) on their surface. In addition, the authors have observed that the nonwoven mat shrinks less when treated at hight temperatures when the nonwoven mat comprises a mixture of man-made inorganic fibers in which part of said fibers have and part of the fibers do not have hydroxyl groups (OH) on their surface, improving its quality.

In the context of the present invention, the term “binder” refers to a substance that helps the man-made inorganic fibers to stick together by adhesion or cohesion. In the context of the present invention the expression “polymeric binder” refers to a binder in the dispersion of step (i) and the expression “at least a binder” refers to a binder or binders added in the mixture of step (iv) or in the nonwoven mat.

In a particular embodiment, the polymeric binder is a polymer selected from a thermoplastic polymer, polyacrylate, polyurethane, epoxy resins, phenol resins, thermo curing resins, light sensitive resins, polyester resins or mixtures thereof.

In a particular embodiment, the polymeric binder is selected from poly(methyl methacrylate) (PMMA), polycarbonate (PC), polystyrene (PS), polypropylene (PP), polyethylene (PE), polyglycolide (PGA), poly(propylenefumarate) (PPF), polycyanoacrylate (PCA), polycaprolactone (PCL), poly(glycerol sebacate) (PGS), poly(glycerol sebacate acrylate) (PGSA), polyvinylidenefuoride (PVDF), polyvinylidene chloride (PVDC), polyethylene terephthalate (PET), polybutylene therephtalate (PBT), polyphenylene oxide (PPO), polyvinyl chloride (PVC), cellulose acetate (CA), cyclic olefin copolymer (COC), ethylene vinyl acetate (EVA), ethylene vinyl alcohol (EVOH), polytetrafluoroethylene (PTFE), fluorinated ethylene propylene (FEP), perfluoroalkoxy (PEA), ethylene tetrafluoroethylene (ETFE), polyethersulfone (PES), chlorinated poly ethylene (CPE), polylactic acid (PLA), poly 3-hydroxybutyrate (P3HB), polybutylene adipate (PBA), polyethylene adipate (PEA), polybutylene succinate (PBS), polyphenylene sulfide (PPS), polysulfone (PSU), polytrimethylene terephthalate (PTT), polyurethane (PU), polyvinyl acetate, polyvinylidene chloride (PVDC), styrene acrylonitrile (SAN), polyetherketones (PEEK), polyvinylalcohol (PVA), polyhydroxyethylmethacrylate (PHEMA), poly(N-isopropylacrylamide) (PNIPAAm) and mixtures thereof.

In a particular embodiment, the polymeric binder is selected from poly(methyl methacrylate) (PMMA), polycarbonate (PC), polystyrene (PS), polypropylene (PP), polyethylene (PE), polyethylene terephthalate (PET), polybutylene therephtalate (PBT), polyphenylene oxide (PPO), polyvinyl chloride (PVC), cellulose acetate (CA), cyclic olefin copolymer (COC), ethylene vinyl acetate (EVA), ethylene vinyl alcohol (EVOH), polytetrafluoroethylene (PTFE), fluorinated ethylene propylene (FEP), perfluoroalkoxy (PEA), ethylene tetrafluoroethylene (ETFE), polyethersulfone (PES), chlorinated poly ethylene (CPE), polylactic acid (PLA), poly 3-hydroxybutyrate (P3HB), polybutylene adipate (PBA), polyethylene adipate (PEA), polybutylene succinate (PBS), polyphenylene sulfide (PPS), polysulfone (PSU), polytrimethylene terephthalate (PTT), polyurethane (PU), polyvinyl acetate, polyvinylidene chloride (PVDC), styrene acrylonitrile (SAN), polyetherketones (PEEK), polyvinylalcohol (PVA), polyhydroxyethylmethacrylate (PHEMA), poly(N-isopropylacrylamide) (PNIPAAm) and mixtures thereof.

In a particular embodiment, the polymeric binder is a vinyl polymer selected from polyvinyl chloride (PVC), poly(vinyl acetate), polyvinyl alcohol (PVA) and mixtures thereof; preferably polyvinyl alcohol (PVA).

In a particular embodiment, the polymeric binder in the dispersion of step (i) is in between 1 and 20% by weight of the total weight of the dispersion; preferably between 2 and 15%; more preferably between 4 and 10%; even much more preferably of about 6%.

In a particular embodiment, the polymeric binder is a polymer fiber. In an alternative embodiment, the polymeric binder of step (i) is not a polymeric fiber.

The authors of the present invention have observed that a method comprising a first step of providing a dispersion comprising man-made inorganic fibers comprising hydroxyl groups (OH) on their surface and with a mean diameter equal or over 6 microns, a polymeric binder, and a solvent leads to a uniform nonwoven mat with a reduced amount of defects in comparison to using fibers with mean diameters below 6 microns.

In the context of the present invention the expression “dispersion” refers to a mixture or a slurry of at least one solid element, such as man-made inorganic fibers, dispersed in a solvent such as water.

Non-limiting examples of solvents suitable for the present invention are methanol, 2-propanol, chloroform, toluene, anisole, cyclohexane, dimethyl formamide, methanol, dichloromethane, trichloroethane, water, acetone, ethyl acetate, N-methyl-2-pyrrolidone and mixtures thereof. In a particular embodiment, the dispersion of step (i) comprises a solvent selected from methanol, ethanol and water; preferably water.

In a particular embodiment, the dispersion of step (i) is stable. The dispersion provided in step (i) may be prepared by dispersing the man-made inorganic fibers and the polymeric binder and, optionally, other additives, in a suitable solvent by applying energy via mechanical methods known in the art for example by means of dispersers, agitators or by ultrasonic baths and or probes. Other alternatives known in the art to prepare stable dispersions that are suitable for the invention include the addition of surface tension control additives (surfactants) to the dispersion, or modification of the man-made inorganic fibers surface by bound or unbound ligand molecules. The dispersion quality may be assessed by the stability of the dispersions during a certain time without flocculation or precipitation. In particular, the man-made inorganic fibers should not aggregate and flocculate in the time frame of the fabrication process, i.e.: from several minutes to hours. Turbidimetry or nephelometry and/or dynamic light scattering can be used for monitoring the stability of the dispersions.

The authors of the present invention have observed that the use of a polymeric binder in the dispersion improves the stability of said dispersion, i.e. reduces the precipitation and/or flocculation of the man-made inorganic fibers.

In some embodiments, the dispersion further comprises one or more additive admixtures. In some embodiments, the one or more additive admixtures are chosen from thickeners, surfactants, and/or man-made inorganic precursors.

In a particular embodiment, the dispersion of step (i) or the mixture of step (iv) further comprises at least an aerogel, preferably an hydrophobic aerogel.

In a more particular embodiment the dispersion of step (i) or the mixture of step (iv) further comprises a silica aerogel; preferably an amorphous silica aerogel; more preferably a hydrophobic amorphous silica aerogel.

In the context of the present invention, the expression “hydrophobic” is understood as kwnon in the art.

In a particular embodiment, the aerogel is in the form of particles or granules.

In a particular embodiment, the aerogel has mean particle sizes of equal or between 0.01 and 7 milimetres; preferably equal or between 0.04 and 5 milimetres; even more preferably equal or between 0.10 and 4 milimetres; even much more preferably equal or between 1 to 3 milimeters.

In an alternative particular embodiment, the aerogel has mean particle sizes of between 0.1 and 200 micrometres; more preferably between 0.5 and 150 micrometres; even much more preferably between 0.2 and 100 micrometers.

In the context of the present invention, the expression “mean particle sizes” regarding the aerogel it's a parameter that has been measured as the arithmetic mean of the diameters of a representative sample of the plurality of the aerogel particles or granules, in addition, said parameter has been measured by means known in the art such as scanning microscopy.

As used in the present invention, the term “aerogel” refers to a low-density porous material, usually a solid, that was obtained by removing the liquid from a gel comprising a liquid in which the liquid is replaced by a gas or vacuum without shrinking the shape of it, usually by a sol-gel manufacturing process as known in the art. In particular, typically, aerogels have densities of about between 50 and 200 Kg/m³.

Non limiting examples of aerogels that might be used in the present invention are silica aerogels. Silica aerogels are widely known in the art of the present invention, and are commercially available. It is contemplated that any silica aerogel accepted in the art may be used in connection with the present invention. Some examples of non-limiting silica aerogels include those from the companies Cabot, JIOS or Svenska aerogels. Methods of preparing these aerogels are also well known in the art. Generally, a gel is prepared by forming a three-dimensional microstructure. For example, a gel can be prepared, by aggregating colloidal silica particles, for example, under acidic conditions, to form a three-dimensional gel microstructure. Aerogel forms when the gel dries or liquid is removed from the pores of the gel. The fluid can be removed by any suitable method that substantially preserves the microstructure of the gel. For example, the fluid removal method may be supercritical fluid extraction, liquid evaporation, or freeze-drying. The gel can then be molded into particles until a desired final aerogel particle size is obtained.

In a particular embodiment, the dispersion of step (i) further comprises at least one thickener; preferably a polymeric thickener. In the context of the present invention, the term “thickener” refers to a compound that increases the density of the dispersion of step (i). Suitable thickeners according to the present invention include colloidal silica, colloidal alumina, sodium alginate (E-401), potassium alginate (E-402), ammonium alginate (E-403), calcium alginate (E-404) and mixtures thereof.

In a particular embodiment, the dispersion of step (i) further comprises at least one surfactant. Suitable surfactants include anionic surfactants, cationic surfactants, nonionic surfactants, amphoteric surfactants or combinations thereof. Exemplary of the anionic surfactant are carboxylic acid, sulfuric acid ester, sulfonic acid, and phosphoric acid ester type surfactants. Exemplary of the cationic surfactant are amine salt, primary amine salt, secondary amine salt, tertiary amine salt, and quaternary amine salt type surfactants. Exemplary of the nonionic surfactant are ester, ester-ether, and ether type surfactants. Exemplary of the amphoteric surfactant are amino acid and sulfo-betaine type surfactants.

Without being bound to any theory in particular, the authors of the present invention observed that the use of additives improves the dispersion of the fibers in the nonwoven mat. Without being bound to any theory in particular, the authors of the present invention observe that the use of a polymeric binder improves the stability of the nonwoven mat.

### Step (ii)

In the present invention, the nonwoven mat is obtainable by the method described above that comprises a step (ii) of web forming said dispersion to obtain a nonwoven surface. In the context of the present invention, the expression “web forming” is an action known in the art that refers to forming a nonwoven surface that comprises fibers, a particular type of web forming are for example, wet laid and melt spun methods among others. In a particular embodiment the web forming step is performed using a Fourdrinier machine as known in the art.

In a particular embodiment, the step (ii) of web forming comprises wet laid the dispersion of step (i) to obtain a nonwoven surface. In an alternative particular embodiment, the step (ii) of web forming consist of wet laid the dispersion of step (i) to obtain a nonwoven surface. In the context of the present invention, the expression “wet laid” is an action known in the art that refers to flowing a dispersion comprising at least fibers and a solvent, such as the one described on step (i) of the method of the present invention, to a moving belt wherein the fibers form a nonwoven surface.

Step (iii)

In a particular embodiment, the step of drying the nonwoven surface of step (ii) under suction is performed during a period of time between 1 and 300 seconds, preferably between 5 and 120 seconds, more preferably between 5 and 30 seconds.

In a particular embodiment, the step of drying the nonwoven surface under suction is performed at a difference of pressure between 1 mbar and 10 bar, preferably between 2 mbar and 1 bar, more preferably between 5 mbar and 200 mbar.

In a particular embodiment, the step of drying the nonwoven surface under suction refers to draining part of the solvent from the nonwoven surface under suction.

In the context of the present invention the expression “nonwoven surface” refers to a product, sheet, blanket, or layer comprising physicaly entangled man-made inorganic fibers, a polymeric binder that helps said man-made inorganic fibers to stick together by adhesion or cohesion and a solvent.

In a particular embodiment, the nonwoven surface obtained on step (iii) has less than a 40% by weight of the solvent of the total weight of the nonwoven surface; preferably less than 35% by weight, more preferably less than 30% by weight; even much more preferably less than 25% by weight, less than 20% by weight or less than 15% by weight.

Without being bound to any theory in particular, the authors of the present invention believe that drying the nonwoven surface under suction to reach less than 40% by weight of solvent over the total weight of the nonwoven surface, improves the interaction of the man-made inorganic fibers with the binders added on step (iv) improving the mechanical properties of the nonwoven mat of the present invention.

### Step (iv)

In a particular embodiment, the step of infiltrating under suction the nonwoven surface of step (iii) with a mixture comprising at least a binder to obtain an infiltrated nonwoven surface is performed during a period of time between 0.01 and 30 seconds, preferably between 0.1 and 15 seconds, more preferably between 0.5 and 10 seconds.

In a particular embodiment, the step of infiltrating under suction the nonwoven surface of step (iii) with a mixture comprising at least a binder to obtain an infiltrated nonwoven surface is performed at a difference of pressure between 1 mbar and 10 bar, preferably between 2 mbar and 1 bar, more preferably between 5 mbar and 200 mbar.

In a particular embodiment, the step of infiltrating under suction the nonwoven surface of step (iii) with a mixture comprising at least a binder to obtain an infiltrated nonwoven surface is performed at a suction rate of between 20 and 80% of the total suction rate.

In an embodiment, the binder of the mixture of step (iv) is an inorganic binder. In a particular embodiment, the binder of the mixture of step (iv) is selected from silica, alumina, aluminium phosphates, sodium silicate or mixtures thereof; preferably is colloidal silica or colloidal alumnia; more preferably is colloidal silica.

In an embodiment, the binder of the mixture of step (iv) is an organic binder. In a more particular embodiment, the organic binder comprises silicone; poly(vinyl alcohol); ethylene, vinyl acetate or a mixture thereof; preferably ethylene, vinyl acetate or a mixture thereof.

In an embodiment, the binder of the mixture of step (iv) is silicone; preferably a hydrophilic silicone.

In an embodiment, the mixture of step (iv) comprises an organic and an inorganic binder.

In an even more particular embodiment, the organic binder is a dispersion comprising ethylene, vinyl acetate or a mixture thereof. In an embodiment, the dispersion further comprises a compound selected from acrylate, vinyl chloride and/or formaldehyde.

In a particular embodiment, the mixture of step (iv) further comprises a solvent; preferably a solvent selected from methanol, ethanol and water; more preferably water.

In an embodiment, the dispersion of step (i) or the mixture of step (iv) further comprises one or more suitable flame retardants. In an embodiment, suitable flame retardants for the present invention comprise reactive and additive flame retardants as known in the art. The choice of flame retardant often depends on the intended service application of the formulation and the attendant flammability testing scenario governing that application as known in the art. In a more particular embodiment, the flame retardant of the present invention is selected from: an organic flame rertardant such as an organohalogen compound, organophosphorus compound, melamine or polyols; an inorganic flame retardant such as aluminium hydroxide (ATH), magnesium hydroxide (MDH), huntite and hydromagnesite; or mixtures thereof. Non-limiting examples of such flame retardants include chlorinated phosphate esters, chlorinated paraffins, melamine, ammonium polyphosphates, polyols and mixtures thereof.

In a particular embodiment, the mixture of step (iv) comprises:
an inorganic binder selected from silica, alumina, aluminium phosphates, sodium silicate or mixtures thereof;
an organic binder comprising poly(vinyl alcohol), ethylene, vinyl acetate or a mixture thereof;
optionally silicone;
optionally a flame retardant; and
water.

In a particular embodiment, the mixture of step (iv) consist of:
an inorganic binder selected from silica, alumina, aluminium phosphates, sodium silicate or mixtures thereof;
an organic binder comprising poly(vinyl alcohol), ethylene, vinyl acetate or a mixture thereof;
optionally silicone;
optionally a flame retardant; and
water.

Without being bound to any theory in particular, the authors of the present invention believe that infiltrating under suction the nonwoven surface with a mixture comprising at least a binder leads to a homogeneous dispersion of the binder through the whole nonwoven surface and a better interaction of said binder with the man-made inorganic fibers, improving the mechanical properties of the final nonwoven mat.

### Step (v)

In the present invention, the nonwoven mat is obtainable by the method described above that comprises a step (v) of heating the infiltrated nonwoven surface obtained in step (iv) at a temperature between 3° and 300° C.

In a particular embodiment, the heating of step (v) is performed under air.

In a particular embodiment, the heating of step (v) is performed at a temperature between 5° and 250° C., preferably between 10° and 200° C.; more preferably between 12° and 180° C.

In a particular embodiment, the heating of step (v) is performed during between 5 seconds and 60 minutes; preferably during between 10 seconds and 40 minutes, more preferably during between 15 seconds and 30 minutes.

In a particular embodiment, the heating of step (iii) is performed by infrared radiation. In a particular embodiment, the heating of step (iii) is performed in a furnace; preferably in an infrared furnace.

### Nonwoven Surface

In the context of the present invention, the expression “nonwoven surface” refers to a product, sheet, blanket, or layer comprising a plurality of physically entangled man-made inorganic fibers that comprise hydroxyl groups (OH) on their surface, wherein said plurality of man-made inorganic fibers have a mean diameter equal or over 6 microns, a polymeric binder and solvent. Said nonwoven surface has porosity; wherein the pores are the ones left by the man-made inorganic fibers interstices. The expression “nonwoven surface” could also be referred to as “nonwoven product”, “nonwoven sheet”, “nonwoven blanket” or “nonwoven layer”. The term “surface” regarding the nonwoven surface is understood as referring to a nonwonven product such as a nonwoven sheet, blanket or layer having a certain thickness in its shorter dimension, as known in the art.

In a particular embodiment, the nonwoven surface has a thickness equal or over 0.1 milimeters; preferably equal or over 0.5 milimeters; more preferably equal or over 1 milimeters.

In a particular embodiment, the nonwoven surface has a thickness equal or between 0.1 and 10 milimeters; preferably equal or between 0.5 and 8 milimeters; more preferably equal or between 1 and 5 milimeters.

### Nonwoven Mat

The nonwoven mat of the present invention may comprise:
a plurality of man-made inorganic fibers comprising hydroxyl groups (OH) on their surface, wherein said plurality of man-made inorganic fibers have a mean diameter equal or over 6 microns;
a polymeric binder;
at least an infiltrated binder; and
   optionally, wherein the nonwoven mat has a density of between 20 kg/m³ and 1000 kg/m³.

The authors of the present invention have observed that the distribution of the polymeric binder and the infiltrated binder in the nonwoven mat and their interaction with the fibers are consequence of the different steps of the method of fabrication of said nonwoven mat, and affect the final characteristics of said mat such as their mechanical and electrical conductivity properties.

In an embodiment, the nonwoven mat of the present invention consist of:
a plurality of man-made inorganic fibers comprising hydroxyl groups (OH) on their surface, wherein said plurality of man-made inorganic fibers have a mean diameter equal or over 6 microns;
optionally a plurality of man-made inorganic fibers not comprising hydroxyl groups (OH) on their surface such as annealed man-made inorganic fibers;
a polymeric binder;
at least an infiltrated binder; and
   optionally, wherein the nonwoven mat has a density of between 20 kg/m³ and 1000 kg/m³.

In another embodiment, the nonwoven mat of the present invention consists of:
a plurality of:
   (a) man-made inorganic fibers comprising hydroxyl groups (OH) on their surface, and
   (b) a plurality of man-made inorganic fibers not comprising hydroxyl groups (OH) on their surface such as annealed man-made inorganic fibers;
wherein said plurality of man-made inorganic fibers have a mean diameter equal or over 6 microns;
a polymeric binder;
at least an infiltrated binder; and
   optionally, wherein the nonwoven mat has a density of between 20 kg/m³ and 1000 kg/m³.

In another embodiment, the nonwoven mat of the present invention consists of:
a plurality of:
   (a) man-made inorganic fibers comprising hydroxyl groups (OH) on their surface, and
   (b) a plurality of man-made inorganic fibers not comprising hydroxyl groups (OH) on their surface such as annealed man-made inorganic fibers;
wherein said plurality of man-made inorganic fibers have a mean diameter equal or over 6 microns;
a polymeric binder;
at least an infiltrated binder;
optionally a flame retardant;
optionally silicone; and
   optionally, wherein the nonwoven mat has a density of between 20 kg/m³ and 1000 kg/m³.

In a particular embodiment, the nonwoven mat comprises the at least a binder of step (iv) or its derivates homogeneously dispersed through the whole nonwoven mat, in particular, throught its whole thickness. In the context of the present invention the expression “derivates of the at least a binder of step (iv)” refers to the compounds generated after heating the at least a binder at a temperature of between 3° and 300° C. of step (v).

The man-made inorganic fibers, the polymeric binder or the at least one infiltrated binder of the nonwoven mat of the invention may have all the characteristics described above for the man-made inorganic fibers, polymeric binder of step (i) or at least one binder of step (iv) respectively.

In a particular embodiment the nonwoven mat has a porosity of at least 50%, preferably at least 60%, more preferably at least 70%; even much more preferably at least 80%.

In the context of the present invention the expression “porosity” in relation the nonwoven surface or the nonwoven mat, refers to a void fraction created by the pores or the interstices among the fibers. The porosity is understood as a fraction of the volume of voids over the total volume expressed as a percentage between 1% and 100%. Therefore, in the context of the present invention, the term “pore” in singular or plural refers to the interstices among the man-made inorganic fibers in any one of the nonwoven surface or mat. Preferably, said pores have averaged diameters between 1 and 100 microns; preferably between 5 and 50 microns.

In a particular embodiment the nonwoven mat has a density of at least 20 kg/m³; preferably at least 30 kg/m³; more preferably at least 50 kg/m³; even much more preferably at lest 60 kg/m³.

In a particular embodiment the nonwoven mat has a density of between 20 kg/m³ and 1000 kg/m³; preferably between 30 and 900 kg/m³; more preferably between 50 and 850 kg/m³; even much more preferably between 60 and 800 kg/m³.

In a more particular embodiment, the nonwoven mat obtainable by the method described above, has a thickness between 0.05 and 20 mm; preferably between 0.10 and 15 mm; more preferably between 0.15 and 10 mm; even more preferably equal or between 0.2 and 8 mm.

In a more particular embodiment, the nonwoven mat obtainable by the method described above, has at least an infiltrated binder (such as a binder or binders) through the whole nonwoven mat; preferably through the whole thickness of the nonwoven mat. In a particular embodiment, the at least an infiltrated binder is homogeneously distributed through the nonwoven mat.

The authors have observed that the infiltrated binder or binders are homogeneously dispersed through the whole thicknes of the nonwoven mat improving the mechanical and electrical conductivity properties of said mat.

### Methods

In another aspect, the present invention is directed to a method for the preparation of the nonwoven mat for thermal insulation and fire protection comprising the steps of
i) providing a dispersion comprising:
   a plurality of man-made inorganic fibers comprising hydroxyl groups (OH) on their surface, wherein said plurality of man-made inorganic fibers have a mean diameter equal or over 6 microns;
   a polymeric binder; and
   a solvent;
ii) web forming the dispersion of step (i) to obtain a nonwoven surface;
iii) drying the nonwoven surface of step (ii) under suction until the nonwoven surface has less than a 40% in weigh of the solvent;
iv) infiltrating under suction the nonwoven surface of step (iii) with a mixture comprising at least a binder to obtain an infiltrated nonwoven surface; and
v) heating the infiltrated nonwoven surface obtained in step (iv) at a temperature between 3° and 300° C.

In an embodiment, the method for the preparation of the nonwoven mat for thermal insulation consists of the following steps
i) providing a dispersion comprising:
   a plurality of man-made inorganic fibers comprising hydroxyl groups (OH) on their surface, wherein said plurality of man-made inorganic fibers have a mean diameter equal or over 6 microns;
   a polymeric binder; and
   a solvent;
ii) web forming said dispersion to obtain a nonwoven surface;
iii) drying the nonwoven surface of step (ii) under suction until the nonwoven surface has less than a 40% in weigh of the solvent;
iv) infiltrating under suction the nonwoven surface of step (iii) with a mixture comprising at least a binder to obtain an infiltrated nonwoven surface; and
v) heating the infiltrated nonwoven surface obtained in step (iv) at a temperature between 3° and 300° C.

The methods described above present all the advantages and characteristics as defined above for the method steps defined above for the nonwoven mat of the present invention in any of its embodiments.

### Partition Member, Battery Housing and Battery Pack.

In a further aspect, the present invention is directed to a partition member adapted for forming a partition between two battery cells or between a single battery cell and a member other than said single battery cell, wherein the partition member comprises at least one nonwoven mat of the present invention as described in any of its particular embodiments.

In a particular embodiment, the partition member consists of one or more nonwoven mats of the present invention as described in any of its particular embodiments; preferably consist of one nonwoven mat of the present invention as described in any of its particular embodiments.

In an additional aspect, the present invention is directed to a battery housing that defines at least a cavity, preferably an open cavity, for receiving, preferably housing, at least one battery cell and preferably a plurality of battery cells forming a pack of cells; wherein the battery housing comprises the partition member of the present invention as described in any of its particular embodiments.

In an additional aspect, the present invention is directed to a battery housing that comprises a nonwoven mat according to any of the previously disclosed embodiments, the battery housing defines at least a cavity, preferably an open cavity, for receiving, preferably housing, at least one battery cell and preferably a plurality of battery cells forming a pack of cells.

In a particular embodiment, the battery housing consist of at least one nonwoven mat according to any of the previously disclosed embodiments; in a more particular embodiment, the battery housing consist of one nonwoven mat according to any of the previously disclosed embodiments.

In a particular embodiment, the battery housing further comprises the partition member of the present invention as described in any of its particular embodiments.

In a particular embodiment, the plurality of battery cells comprises a partition member separating at least two cells or separating a single battery cell and a member other than said single battery cell; wherein the partition member is preferably the partition member of the present invention as described in any of its particular embodiments.

According to a preferred embodiment, the battery housing is made by blending one or more a die-cut sheets; preferably consisting of at least one nonwoven mat according to any of the previously disclosed embodiments; more pferably consisting of one nonwoven mat according to any of the previously disclosed embodiments. In a preferred embodiment the one or more bent die-cut sheets forms a base and one or more lateral walls.

In another aspect, the present invention is directed to a battery pack comprising:
a plurality of batteries, and
the battery housing of the present invention as described in any of its particular embodiments.

### Uses

In another aspect, the present invention is directed to the use of the nonwoven mat, the partition member or the battery housing of the invention, for thermal insulation; preferably for thermal insulation of batteries; more preferably for thermal insulation of batteries of electric vehicles.

In an alternative aspect, the present invention is directed to a method for thermally insulating an object or objects that comprises separating said object or objects from other object or objects with the nonwoven mat, the partition member or the battery housing of the invention; preferably wherein the object or objects are one or more batteries; more preferably one or more batteries of electric vehicles.

In another aspect, the present invention is directed to the use of the nonwoven mat, the partition member, or the battery housing of the invention for fire protection, preferably for protecting batteries from fire; more preferably for protecting electric vehicle batteries from fire.

In an alternative aspect, the present invention is directed to a method for protecting from fire an object or objects that comprises separating said object or objects from other object or objects with the nonwoven mat, the partition member or the battery housing of the invention; preferably wherein the object or objects are one or more batteries; more preferably one or more batteries of electric vehicles.

The nonwoven mat, the partition member, the battery housing, the battery pack, the method for the preparation of the nonwoven mat, and the use of the nonwoven mat present all the advantages and characteristics as defined above for the nonwoven mat of the present invention in any of its embodiments.

Throughout the description and claims the word “comprises” and variations of the word, are not intended to exclude other technical features, additives, components or steps. Furthermore, the word “comprise” encompasses the case of “consisting of”. Additional objects, advantages and features of the invention will become apparent to those skilled in the art upon examination of the description or may be learned by practice of the invention.

The following examples are provided by way of illustration, and they are not intended to be limiting of the present invention. Furthermore, the present invention covers all possible combinations of particular and preferred embodiments described herein.

### Examples

The invention is illustrated by means of the following examples which in no case limit the scope of the invention.

Example 1: Preparation of a Nonwoven Mat Infiltrated with Colloidal Silica.

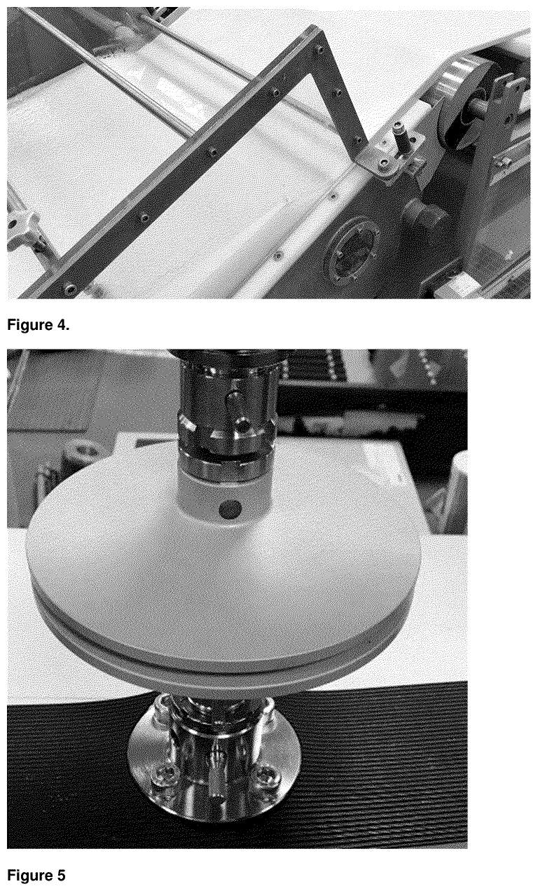

A nonwoven mat was prepared according to an adapted “web forming” technology (see FIG. 4) based in the technology employed by the paper industry that uses a Fourdrinier machine, as follows. Man-made inorganic fibers comprising hydroxyl groups (OH) on their surface and with a mean diameter equal or over 6 microns obtained under the trademark designation “BELCOTEX(R)®” from BELCHEM were used. Said man-made inorganic fibers were dispersed in water by applying mechanical energy using a disperser in an open vessel. Poly(vinyl alcohol) (PVA) was also added to the dispersion as polymeric binder. Then, a nonwoven surface comprising the man-made inorganic fibers and PVA was formed in continuous by web forming the dispersion described above using a Fourdrinier machine (i.e. depositing the dispersion on top of a continuous moving framed belt). The nonwoven surface was then dewatered under suction with a vacuum pump until it reaches between a 25 and a 20% percentage of water by weigh over the total weight of the nonwoven surface.

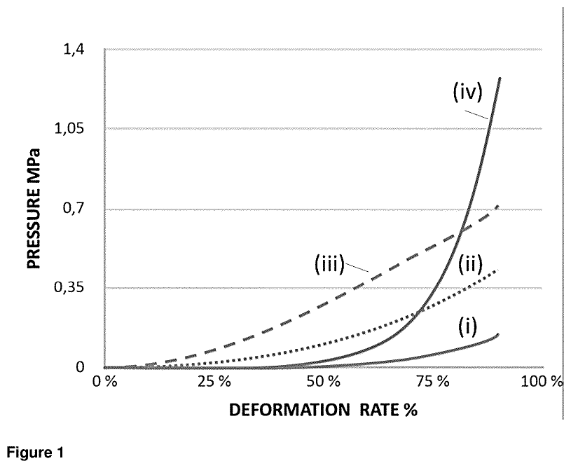

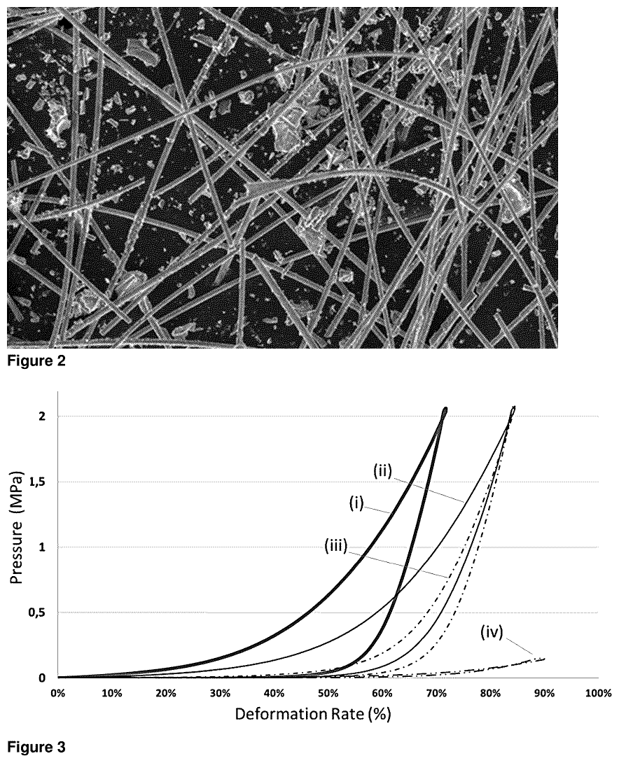

A composition of colloidal silica (Ludox®) in water was infiltrated into the nonwoven surface under suction to obtain an infiltrated nonwoven surface. Then, the infiltrated nonwoven surface was stabilized and dried under heating in an infrared oven at a temperature between 3° and 300° C. to obtain a nonwoven mat having a density of 60 kg/m³ (see FIG. 1(i) and FIG. 2).

The nonwoven mat deformation rate (%) under pressure was tested using a Shimadzu® machine based on an ASTM D3574 standard method known in the art (see FIG. 5). Results obtained for said nonwoven mat are showed on FIG. 1(i).

The applicants have observed than using man-made inorganic fibers comprising hydroxyl groups (OH) on their surface and with a mean diameter equal or over 6 microns, leads to a reduced amount of water in the nonwoven surface before impregnation with binders. This, together with the addition of impregnated binders under suction results in better mechanical and insulating properties in the final nonwoven mat in comparison with nonwoven mats obtained using other types of fibers. The authors have observed that this effect is particularly relevant when using man-made inorganic fibers comprising hydroxyl groups (OH) on their surface and having a mean diameter around 11 microns.

The same process that the one described above in the present example was repeated but infiltrating the nonwoven surface with different amounts of organic or inorganic binders. In particular, FIG. 1 shows the results for deformation rates (%) under pressure for nonwoven mats having increasing amounts of inorganic binder with final densities of (i) 60 (ii) 90 and (iii) 390 Kg/m³ and with an organic binder leading to a final density of the nonwoven mat of (iv) 60 kg/m³. Results show that organic and inorganic binders have different effects in the mechanical properties of the nonwoven mat. In addition, results also show that different amounts of inorganic binders modify the mechanical properties of the nonwoven mats.

Example 2: Preparation of a Nonwoven Mat Infiltrated with Colloidal Silica, a Mixture of Colloidal Silica and a Polymeric Binder, and Polymeric Binder.

A nonwoven mat was prepared according to the procedure described in Example 1 but infiltrating with (i) colloidal silica, (ii) a mixture of colloidal silica and a polymeric organic binder; and (iii) and (iv) polymeric organic binder (see FIG. 3 below). The polymeric organic binder was produced from the monomers vinyl acetate and ethylene in water (VINNAPAS® EN 428). The nonwoven mats deformation rate (%) under pressure was tested and results are showed on FIG. 3 for nonwoven mats with densities of (i) 167 kg/m³ being only infiltrated with inorganic binder; (ii) 231 kg/m³ being infiltrated with inorganic and polymeric organic binder, (iii) 85 kg/m³ being infiltrated with polymeric organic binder and (iv) 60 kg/m³ being infiltrated with polymeric organic binder.

Results show that the method of the present invention allows obtaining nonwoven mats with tunable mechanical properties. In addition, nowonven mats infiltrated with a mixture of inorganic and polymeric organic binders have deformation rate properties between those infiltrated only with inorganic and only with polymeric organic binders.

### Example 3: Preparation of a Nonwoven Mat Comprising Two Types of Fibers.

A nonwoven mat was prepared according to the procedure described in Example 1 but comprising about a 50% of the total weight of fibers being man-made inorganic fibers comprising hydroxyl groups (OH) on their surface and about a 50% of the total weight of the fibers being the same type of fibers but not comprising hydroxyl groups (OH) on their surface. The applicants have observed an improvement in the deformation response of the nonwoven mat under pressure when the two types of fibers described above were used. In addition, the nonwoven mat shows less defects (particularly a reduced amount of surface defects, for example showing a smooth surface) when those two types of fibers are used that when only one type of fiber is used.

Example 4: Preparation of a Nonwoven Mats Infiltrated with the Same Binders but Using Different Suction Rates.

Nonwoven mats having the same final density were prepared according to the same procedure described in Example 1 but using different suction rates (expressed as % over the total capacity of the vacuum pump used for suctioning) during the step of infiltration with binders. In the present example all the samples were infiltrated with the same binder composition comprising a polymeric binder (VINNAPAS® EAF68). The nonwoven mats deformation rate (%) under pressure were tested and results are showed on Table 1 below.

TABLE 1

| Final | Density | Suction | Deformation |
|---|---|---|---|
| density of | before binder | rate | rate |
| nonwoven mat | infiltration | (%) | (%) |
| 81 | 60 | 100 | 11 |
| 81 | 60 | 65 | 5 |
| 71 | 61 | 100 | 4 |
| 71 | 62 | 85 | 1 |

Table 1 results show that the step of infiltrating the binders under suction has an effect in the final deformation properties of the nonwoven mat under pressure even when the final density of the nonwoven mat is the same.

### Example 5: Preparation of a Battery Housing.

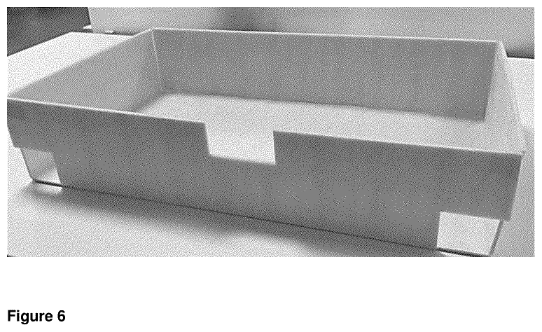

A battery housing was made by blending two die-cut sheets consisting of the nonwoven mat of example 1. FIG. 6 shows one piece of said battery housing.

### Example 6: Preparation of a Battery Pack.

A battery pack is prepared by introducing a plurality of batteries in the battery housing of example 5.

1. A nonwoven mat for thermal insulation and protection from fire obtainable by a method comprising the steps of:
i) providing a dispersion comprising:
a plurality of man-made inorganic fibers comprising hydroxyl groups (OH) on their surface and wherein said plurality of man-made inorganic fibers have a mean diameter equal or over 6 microns;
a polymeric binder; and
a solvent;
ii) web forming the dispersion of step (i) to obtain a nonwoven surface;
iii) drying the nonwoven surface of step (ii) under suction until the nonwoven surface has less than a 40% by weight of the solvent with respect to the total weight of the nonwoven surface;
iv) infiltrating under suction the nonwoven surface of step (iii) with a mixture comprising at least a binder to obtain an infiltrated nonwoven surface; and
v) heating the infiltrated nonwoven surface obtained in step (iv) at a temperature between 3° and 300° C. to obtain a nonwoven mat.

2. The nonwoven mat according to claim 1, wherein the polymeric binder of step (i) is in an amount of between 4 and 10% by weight of the total weight of the dispersion.

3. The nonwoven mat according to claim 1, wherein the at least a binder of the mixture of step (iv) is an inorganic binder.

4. The nonwoven mat according to claim 1, wherein the at least a binder of the mixture of step (iv) is an inorganic binder selected from silica, alumina, aluminium phosphates, sodium silicate or mixtures thereof; an organic binder selected from poly(vinyl alcohol), a dispersion comprising ethylene vinyl acetate or a mixture thereof; or a mixture thereof.

5. (canceled)

6. (canceled)

7. The nonwoven mat according to claim 1, wherein the polymeric binder of step (i) is selected from the following list poly(methyl methacrylate) (PMMA), polycarbonate (PC), polystyrene (PS), polypropylene (PP), polyethylene (PE), polyglycolide (PGA), poly(propylene fumarate) (PPF), polycyanoacrylate (PCA), polycaprolactone (PCL), poly(glycerol sebacate) (PGS), poly(glycerol sebacate acrylate) (PGSA), polyvinylidenefuoride (PVDF), polyvinylidene chloride (PVDC), polybutylene therephtalate (PBT), polyphenylene oxide (PPO), polyvinyl chloride (PVC), cellulose acetate (CA), cyclic olefin copolymer (COC), ethylene vinyl acetate (EVA), ethylene vinyl alcohol (EVOH), polytetrafluoroethylene (PTFE), fluorinated ethylene propylene (FEP), perfluoroalkoxy (PEA), ethylene tetrafluoroethylene (ETFE), polyethersulfone (PES), chlorinated poly ethylene (CPE), polylactic acid (PLA), poly 3-hydroxybutyrate (P3HB), polybutylene adipate (PBA), polyethylene adipate (PEA), polybutylene succinate (PBS), polyphenylene sulfide (PPS), polysulfone (PSU), polytrimethylene terephthalate (PTT), polyurethane (PU), polyvinyl acetate, polyvinylidene chloride (PVDC), styrene acrylonitrile (SAN), polyetherketones (PEEK), polyvinylalcohol (PVA), polyhydroxyethylmethacrylate (PHEMA), poly(N-isopropylacrylamide) (PNIPAAm) and mixtures thereof.

8. The nonwoven mat according to claim 1, wherein the polymeric binder of step (i) is poly(vinyl alcohol).

9. The nonwoven mat according to claim 1, wherein the man-made inorganic fibers comprising hydroxyl groups (OH) on their surface further comprise Al and Si.

10. The nonwoven mat according to claim 1, wherein the dispersion of step (i) further comprises man-made inorganic fibers not having hydroxyl groups (OH) on their surface.

11. The nonwoven mat according to claim 1, wherein the dispersion of step (i) further comprises man-made inorganic fibers not having hydroxyl groups (OH) on their surface, and wherein the man-made inorganic fibers comprising hydroxyl groups (OH) on their surface of the dispersion of step (i) comprise greater than 30% by weight of the total man-made inorganic fibers of the dispersion.

12. The nonwoven mat according to claim 1, having a density of between 20 kg/m³ and 1000 kg/m³.

13. The nonwoven mat according to claim 1, wherein the dispersion of step (i) or the mixture of step (iv) further comprises at least an aerogel.

14. The nonwoven mat according to claim 1, wherein the dispersion of step (i) or the mixture of step (iv) further comprises silicone or polysiloxane.

15. The nonwoven mat according to claim 1, wherein the dispersion of step (i) or the mixture of step (iv) further comprises a flame retardant.

16. The nonwoven mat according to claim 1, wherein the polymeric binder of step (i) is not a polymeric fiber.

17. A method for the preparation of the nonwoven mat for thermal insulation comprising the steps of
i) providing a dispersion comprising:
a plurality of man-made inorganic fibers comprising hydroxyl groups (OH) on their surface, wherein said plurality of man-made inorganic fibers have a mean diameter equal or over 6 microns;
a polymeric binder; and
a solvent;
ii) web forming the dispersion of step (i) to obtain a nonwoven surface;
iii) drying the nonwoven surface of step (ii) under suction until the nonwoven surface has less than a 40% by weight of the solvent of the total weight of the nonwoven surface;
iv) infiltrating under suction the nonwoven surface of step (iii) with a mixture comprising at least a binder to obtain an infiltrated nonwoven surface; and
v) heating the infiltrated nonwoven surface obtained in step (iv) at a temperature between 3° and 300° C. to obtain a nonwoven mat.

18. A partition member adapted for forming a partition between two battery cells or between a single battery cell and a member other than said single battery cell, wherein the partition member comprises at least one nonwoven mat according to claim 1.

19. A battery housing that defines at least an open cavity for receiving at least one battery cell; wherein the battery housing comprises the nonwoven mat according to 1.

20. (canceled)

21. Method for thermally insulating an object or objects that comprises separating said object of objects from other object or objects with the nonwoven mat according to claim 1.

22. Method for protecting from fire an object or objects that comprises separating said object of objects from other object or objects with the nonwoven mat according to claim 1.

23. A battery pack comprising:
a plurality of batteries, and
the nonwoven mat according to claim 1.
